(19) United States
(12) Patent Application Publication
(10) Pub. No.: US 2022/0206297 A1
(43) Pub. Date: Jun. 30, 2022

(54) PROJECTION OPTICAL SYSTEM AND HEAD-UP DISPLAY DEVICE MOUNTED ON AUTOMOBILE

(71) Applicant: IVIEW DISPLAYS (SHENZHEN) COMPANY LTD., Shenzhen (CN)

(72) Inventors: Weizhan Zhu, Shenzhen (CN); Xiaofeng Tang, Shenzhen (CN); Mingnei Ding, Shenzhen (CN); Steve Yeung, Hong Kong (CN); Zhiqiang Gao, Hong Kong (CN)

(21) Appl. No.: 17/544,106

(22) Filed: Dec. 7, 2021

Related U.S. Application Data
(63) Continuation of application No. PCT/CN2021/083358, filed on Mar. 26, 2021.

(30) Foreign Application Priority Data
Dec. 28, 2020 (CN) 202011577348.9

(51) Int. Cl. G02B 27/01; G02B 13/22; G02B 17/08; B60K 35/00

(52) U.S. Cl. CPC G02B 27/0101; G02B 13/22; G02B 17/08; B60K 35/00; B60K 2370/334; B60K 2370/1529; B60K 2370/23; B60K 2370/31; G02B 2027/014

(57) ABSTRACT

A projection optical system applicable to a head-up display device mounted on an automobile includes an image generation unit, a first reflection unit, a double-telecentric lens, a light splitting device, a first lens, a second reflection unit, and a second lens that are successively arranged in a light exit direction; and a controller connected to the image generation unit and the light splitting device. The light splitting device with sector shape top view arranges on an image side of the double-telecentric lens. When the image generation unit emits a first image, the light splitting device swings to a first angle, such that the first image is emitted and imaged through the first lens and when the image generation unit emits a second image, the light splitting device swings to an initial position, such that the second image is emitted and imaged through the second lens.

### CROSS-REFERENCE TO RELATED APPLICATION

This application is based upon and claims priority to Chinese Patent Application No. 202011577348.9, filed before China National Intellectual Property Administration on Dec. 28, 2020 and entitled “PROJECTION OPTICAL SYSTEM AND HEAD-UP DISPLAY DEVICE MOUNTED ON AUTOMOBILE,” the entire contents of which are incorporated herein by reference.

### TECHNICAL FIELD

Embodiments of the present disclosure relate to the technical field of projection optics, and in particular, relate to a projection optical system and a head-up display device mounted on an automobile.

### BACKGROUND

A head-up display (HUD) refers to a display mounted on a front windshield of an automobile. Nowadays, with transformation of the automobile towards intelligence, at present, newly designed intelligent automobiles are all mounted with HUDs, and drivers are capable of knowing speed, speed limitation signs, drive routes and the like vehicle information and road condition information with no need of lowering heads to check instrument panels. Augmented reality HUDs (AR HUDs) are prevailing currently. An AR HUD is a head-up display device capable of displaying AR pictures.

During practice of embodiments of the present disclosure, the applicant has found that the related art has at least the following problem: At present, the HUD, that is, the head-up display device, mounted on the automobile is only capable of displaying a two-dimensional planar picture, for example, a driving information picture of the automobile, or is only capable of displaying an AR picture, for example, a picture displaying road condition information captured by a camera of the automobile. Where these two pictures need to be simultaneously displayed, two head-up display devices are needed. As such, a sufficient space needs to be reserved at the front portion of the body of the automobile to receive two HUDs.

### SUMMARY

With respect to the defects in the related art, objects of embodiments of the present disclosure are to provide a projection optical system capable of projecting and imaging two pictures, and a head-up display device mounted on an automobile.

The objects of the embodiments of the present disclosure are achieved by employing the following technical solutions:

In view of the above technical problem, in a first aspect, the embodiments of the present disclosure provide a projection optical system applicable to a head-up display device mounted on an automobile. The projection optical system includes: an image generation unit, configured to emit light beams including image information of a first image and a second image;

a first reflection unit, a light incident side of the first reflection unit being arranged in a light exit direction of the image generation unit;

a double-telecentric lens, a light incident side of the double-telecentric lens being arranged in a light exit direction of a light reflection side of the first reflection unit;

a light splitting device, a light incident side of the light splitting device being arranged in a light exit direction of a light exit side of the double-telecentric lens, the light splitting device being arranged on an image side of the double-telecentric lens, and the light splitting device being in a sector shape in a top view direction;

a first lens, a light incident side of the first lens being arranged in a light exit direction of a light reflection side of the light splitting device;

a second reflection unit, a light incident side of the second reflection unit being arranged in a light exit direction of the double-telecentric lens;

a second lens, a light incident side of the second lens being arranged in a light exit direction of a light reflection side of the second reflection unit; and

a controller, connected to the image generation unit and the light splitting device, and configured to control, based on timing, an image emitted from the image generation unit and the light splitting device to swing; wherein

the controller is configured to control, in response to controlling the image generation unit to emit the first image, the light splitting device to swing from an initial position to a first angle to reflect light exiting from the double-telecentric lens, such that the first image is emitted and imaged through the first lens, or

the controller is configured to control, in response to controlling the image generation unit to emit the second image, the light splitting device to swing to an initial position to not reflect light exiting from the double-telecentric lens, such that the second image is emitted and imaged through the second lens.

In some embodiments, the light splitting device is a sector-shaped mirror, and the light splitting device is configured to swing about a center thereof as a central axis; and the projection optical system further includes:

a first driving device, connected to the controller and the light splitting device, and configured to drive, in response to a control instruction issued by the controller, the light splitting device to swing and move; wherein

in response to swinging to the first angle, the light splitting device is positioned in an optical path in the light exit direction of the double-telecentric lens, such that the light beam of the first image is reflected into the first lens, or

in response to swinging to the initial position, the light splitting device is not positioned in an optical path in the light exit direction of the double-telecentric lens, such that the light beam of the second image is reflected by the second reflection unit into the second lens.

In some embodiments, the automobile further includes a front windshield, wherein the front windshield is a diffuser, and in the projection optical system, relay images of the first lens and the second lens are imaged on the front windshield;

the controller is further connected to the first lens and the second lens, and configured to adjust, by controlling positions of the first lens and the second lens, a virtual image distance between the first image and the second image in response to the first image and the second image being imaged on the front windshield; and

the projection optical system further includes:

a second driving device, connected to the controller and the first lens, and configured to drive, in response to a control instruction issued by the controller, the first lens to adjust an imaging position of light exiting from the first lens; and

a third driving device, connected to the controller and the second lens, and configured to drive, in response to a control instruction issued by the controller, the second lens to adjust an imaging position of light exiting from the second lens.

In some embodiments, the double-telecentric lens includes a first refractive lens group and a second refractive lens group, and the controller is configured to adjust a size of the image by controlling positions of the first refractive lens group and the second refractive lens group in the double-telecentric lens; and

the projection optical system further includes:

a fourth driving device, connected to the controller and the double-telecentric lens, and configured to drive, in response to a control instruction issued by the controller, the first refractive lens group and the second refractive lens group to adjust image sizes of light exiting from the first refractive lens group and the second refractive lens group.

In some embodiments, the first reflection unit is a turning prism, arranged at a first predetermined angle between the image generation unit and the double-telecentric lens; and

the second reflection unit is a mirror, arranged at a second predetermined angle between the light splitting device and the second lens.

In some embodiments, an optical power of the first refractive lens group is 15 mm, and a focal length of the first refractive lens group is 8.6 mm; and

an optical power of the second refractive lens group is 8 mm, and a focal length of the second refractive lens group is 6 mm.

In some embodiments, an optical power of the first lens is 12 mm, and a focal length of the first lens is 8.6 mm; and

an optical power of the second lens is 40 mm, and a focal length of the second lens is 24 mm.

In some embodiments, an optical power of the light splitting device is 24 mm.

In some embodiments, the image generation unit is a DLP display chip or an LCOS display chip.

In view of the above technical problem, in a second aspect, the embodiments of the present disclosure provide a head-up display device mounted on an automobile. The head-up display device includes the projection optical system according to the first aspect, wherein the projection optical system is capable of projecting the first image and/or the second image onto a front windshield of the automobile such that imaging is achieved on the front windshield.

Compared with the related art, the embodiments of the present disclosure achieve the following beneficial effects: The embodiments of the present disclosure provide a projection optical system applicable to a head-up display device mounted on an automobile. The projection optical system includes an image generation unit, a first reflection unit, a double-telecentric lens, a light splitting device, a first lens, a second reflection unit, and a second lens that are successively arranged in a light exit direction; and further includes a controller connected to the image generation unit and the light splitting device, and configured to control, based on timing, an image emitted from the image generation unit and light exiting from the light splitting device; wherein the light splitting device is in a sector shape in a top view direction, and arranged on an image side of the double-telecentric lens; and the controller is configured to control, in response to controlling the image generation unit to emit a first image, the light splitting device to swing to a first angle, such that the first image is emitted and imaged through the first lens, or the controller is configured to control, in response to controlling the image generation unit to emit a second image, the light splitting device to swing to an initial position, such that the second image is emitted and imaged through the second lens. The projection optical system according to the present disclosure is capable of displaying, by means of timing control, different contents and pictures at two different positions, and in addition, the system has advantages of small size and low cost.

### BRIEF DESCRIPTION OF THE DRAWINGS

One or more embodiments are illustrated by way of example, and not by limitation, in the figures of the accompanying drawings, wherein elements/modules having the same reference numeral designations represent like elements/modules throughout. The drawings are not to scale, unless otherwise disclosed.

FIG. 1 is a schematic diagram of an application scenario of a projection optical system according to an embodiment of the present disclosure;

FIG. 2 is a schematic diagram of imaging on a front windshield in the application scenario in FIG. 1;

FIG. 3 is a schematic structural diagram of a projection optical system according to a first embodiment of the present disclosure;

FIG. 4 is a schematic diagram of an optical path in the projection optical system in FIG. 3;

FIG. 5 is a schematic structural block diagram of electrical connection of the projection optical system according to the first embodiment of the present disclosure;

FIG. 6 is a schematic structural diagram of a light splitting device in a top view direction according to the first embodiment of the present disclosure; and

FIG. 7 is a schematic structural diagram of a head-up display device mounted on an automobile according to a second embodiment of the present disclosure.

### DETAILED DESCRIPTION

The present disclosure is further described with reference to some exemplary embodiments. The embodiments hereinafter facilitate further understanding of the present disclosure for a person skilled in the art, rather than causing any limitation to the present disclosure. It should be noted that persons of ordinary skill in the art may derive various variations and modifications without departing from the inventive concept of the present disclosure. Such variations and modifications shall pertain to the protection scope of the present disclosure.

For clearer descriptions of the objectives, technical solutions, and advantages of the present disclosure, the present disclosure is further described with reference to specific embodiments and attached drawings. It should be understood that the specific embodiments described herein are only intended to explain the present disclosure instead of limiting the present disclosure.

It should be noted that, in the absence of conflict, embodiments of the present disclosure and features in the embodiments may be incorporated, which all fall within the protection scope of the present disclosure. In addition, although function module division is illustrated in the schematic diagrams of apparatuses, and in some occasions, module division different from the divisions of the modules in the apparatuses may be used. Further, the terms “first,” “second,” and the like used in this text do not limit data and execution sequences, and are intended to distinguish identical items or similar items having substantially the same functions and effects.

For ease of definition of the connection structure, positions of the components are defined using a light exit direction of a light beam as a reference. As used herein, the terms “upper,” “lower,” “left,” “right,” “vertical” “horizontal,” and the like expressions are used for illustration purposes only. For ease of definition of the connection structure, positions of the components are defined using a direction in which a light beam is incident to a light splitting device from a top-view direction as a reference.

Unless the context clearly requires otherwise, throughout the specification and the claims, technical and scientific terms used herein denote the meaning as commonly understood by a person skilled in the art. Additionally, the terms used in the specification of the present disclosure are merely for description of the embodiments of the present disclosure, but are not intended to limit the present disclosure. As used herein, the term “and/or” in reference to a list of one or more items covers all of the following interpretations of the term: any of the items in the list, all of the items in the list and any combination of the items in the list.

In addition, technical features involved in various embodiments of the present disclosure described hereinafter may be combined as long as these technical features are not in conflict.

In view of the case where the conventional head-up display device mounted on an automobile is only capable of displaying an image, but incapable of simultaneously displaying a close-up image and a distal image, and/or the case a two-dimensional image and a three-dimensional image need to be simultaneously displayed, embodiments of the present disclosure provide a projection optical system. In the projection optical system, light beams of images emitted by an image generation unit and light exiting from a light splitting device are controlled based on timing, such that the two different images are output through a first lens and a second lens respectively. In this way, different contents and images are respectively displayed at two different positions. In addition, the projection optical system according to the embodiments of the present disclosure has advantages of small size and low cost.

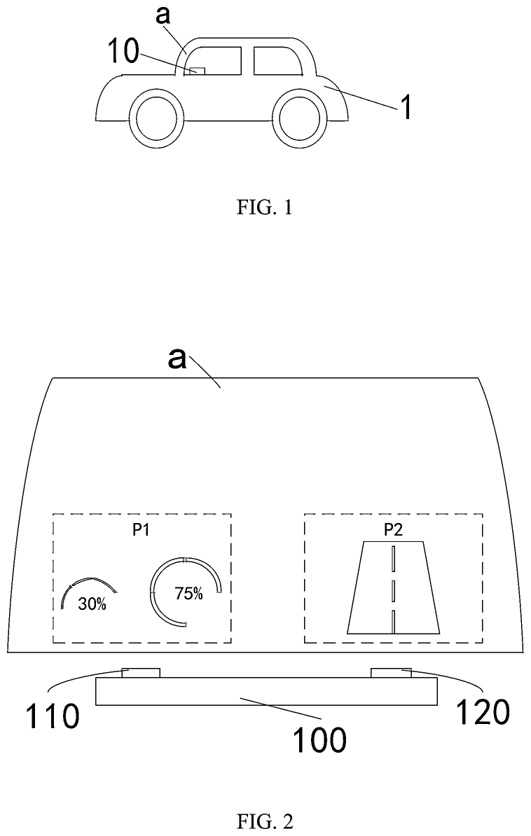

FIG. 1 is a schematic diagram of an application scenario of a projection optical system according to an embodiment of the present disclosure, and FIG. 2 is a schematic diagram of imaging on a front windshield in the application scenario in FIG. 1. The application scenario involves an automobile 1. The automobile 1 includes a front windshield a and a head-up display device 10.

The head-up display device 10 employs a projection optical system 100 according to the embodiment of the present disclosure to achieve imaging and display of two image pictures. The projection optical system 100 is capable of outputting a first image P1 and a second image P2 through a first lens 110 and a second lens 120 respectively.

In this application scenario, the first image P1 is mainly configured to display a two-dimensional image, for example, driving information of the automobile 1, wherein the driving information includes, but is not limited to, speed information, oil supply information, and the like of the automobile 1. Accordingly, the automobile 1 should be equipped with a speed sensor, an oil supply sensor, and the like. Specifically, configurations of the two-dimensional image, the driving information of the automobile 1, and the corresponding sensor may be selected according to the actual needs, which are not limited to those in the application scenario of the present disclosure.

In this application scenario, the second image P2 is mainly configured to display a three-dimensional image, that is, an AR picture, for example, road condition information of a road where the automobile 1 is traveling, wherein the road condition information includes, but is not limited to, lanes, road lines, pedestrian crossings, obstacles, traffic lights, traffic sign boards, and the like. Accordingly, the automobile 1 should be equipped with a camera, a laser radar, and the like detection device. Further, where the automobile 1 is capable of implementing a navigation function, navigation indication information may also be over-displayed together with the road condition information. Specifically, configurations of the three-dimensional image, the road condition information of the road where the automobile 1 is traveling, and the corresponding detection device may be selected according to the actual needs, which are not limited to those in the application scenario of the present disclosure.

In this application scenario, the front windshield a is preferably made of a glass material that is capable of clearly achieving imaging and has a good light transmittance. Specifically, the material may be selected according to the actual needs, which is not limited to that in the application scenario of the present disclosure.

Hereinafter, the embodiments of the present disclosure are further illustrated with reference to the accompanying drawings.

### First Embodiment

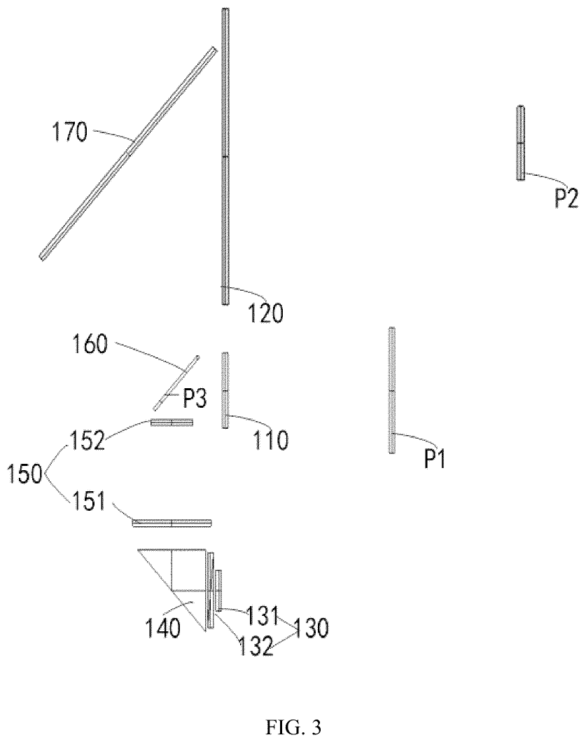

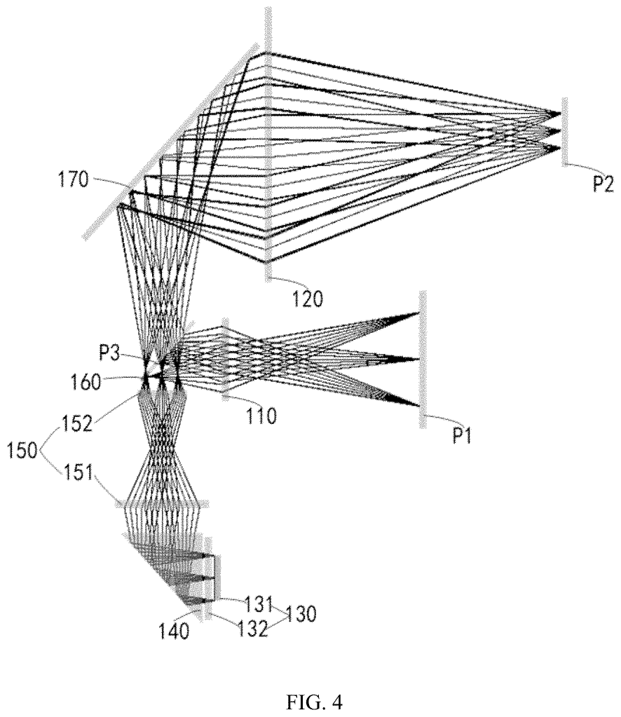

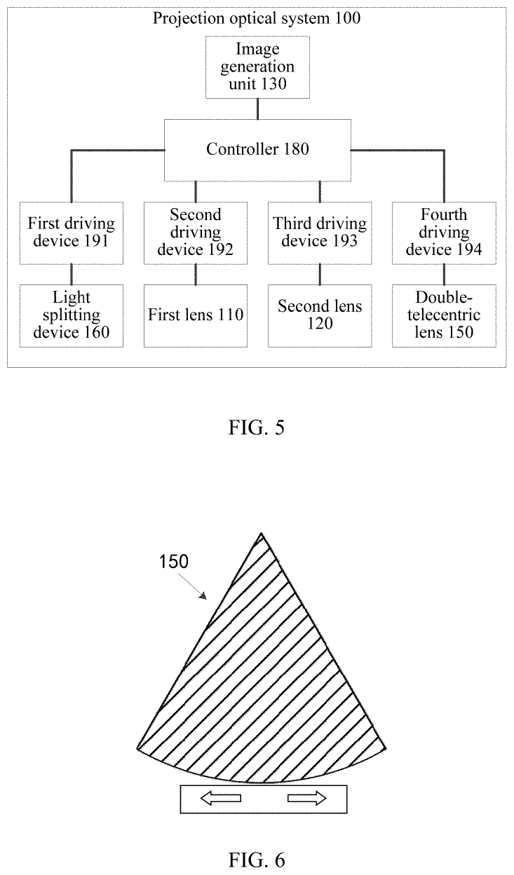

This embodiment of the present disclosure provides a projection optical system, which is applicable to a head-up display device as described in the above application scenario. Collectively referring to FIG. 3, FIG. 4, and FIG. 5, FIG. 3 is a structural diagram of a projection optical system 100 according to an embodiment of the present disclosure, FIG. 4 is a diagram of an optical path of the projection optical system in FIG. 3, and FIG. 5 is a structural block diagram of electrical connection of a projection optical system according to an embodiment of the present disclosure. The projection optical system 100 includes: a first lens 110, a second lens 120, an image generation unit 130, a first reflection unit 140, a double-telecentric lens 150, a light splitting device 160, a second reflection unit 170, a controller 180, a first driving device 191, a second driving device 192, a third driving device 193, and a fourth driving device 194.

The image generation unit 130 is configured to emit light beams including image information of a first image and a second image. The image generation unit 130 is a digital light processing (DLP) display chip or a liquid crystal on silicon (LCOS) display chip. In the embodiment of the present disclosure, the image generation unit 130 includes an effective surface 131 and a projective glass 132. In some other embodiments, the image generation unit 130 may also be a digital micromirror device (DMD) display chip or another image display chip, which may be specifically selected according to the actual needs, and is not limited to that in the embodiment of the present disclosure.

A light incident side of the first reflection unit 140 is arranged in a light exit direction of the image generation unit 130. The first reflection unit 140 is a turning prism arranged at a first predetermined angle between the image generation unit 130 and the double-telecentric lens 150. The turning prism employed by the first reflection unit 140 may be a total internal reflection (TIR) prism to achieve total reflection of the light beams. In the embodiment illustrated in FIG. 4, the first reflection unit 140 employs a right angle prism. One right angle face is opposite to the image generation unit 130. The other right angle face is opposite to the double-telecentric lens 150. An inclined face of the first reflection unit 140 has a reflection angle of 90 degrees, that is, the first predetermined angle of the first reflection unit 140 is 45 degrees, and the first reflection unit 140 is arranged in the optical path at the predetermined angle. In some other embodiments, the model and material of the first reflection unit 140, and the first predetermined angle may be selected according to the actual needs, which are not limited to those in the embodiments of the present disclosure.

A light incident side of the double-telecentric lens 150 is arranged in a light exit direction of a light reflection side of the first reflection unit 140. Further, the double-telecentric lens 150 includes a first refractive lens group 151 and a second refractive lens group 152, and the controller 180 is configured to adjust sizes of the images by controlling positions of the first refractive lens group 151 and the second refractive lens group 152 in the double-telecentric lens 150; the fourth driving device 194 is connected to the controller 180 and the double-telecentric lens 150, and configured to drive, in response to a control instruction issued by the controller 180, the first refractive lens group 151 and the second refractive lens group 152 to adjust image sizes of light exiting from the first refractive lens group 151 and the second refractive lens group 152. The first refractive lens group 151 has an optical power of 15 mm and a focal length of 8.6 mm, and the second refractive lens group 152 has an optical power of 8 mm and a focal length of 6 mm. Specifically, the first refractive lens group 151 and/or the second refractive lens group 152 may be a single lens or a lens group composed of a plurality of lenses, and may also contain other optical instruments. In practical application scenarios, the first refractive lens group 151 and/or the second refractive lens group 152 may be configured according to the actual needs, which are not limited to that in the embodiment of the present disclosure. It should be noted that the optical power and focal length of the first refractive lens group 151 and/or the second refractive lens group 152 are only design parameters obtained by software simulation in the embodiment as illustrated in FIG. 4 of the present disclosure. In practice, depending on different beam propagation paths, the specific design parameters of the first refractive lens group 151 and/or the second refractive lens group 152 may also be other parameters obtained according to software simulation. The examples according to the embodiments of the present disclosure are not intended to construe any limitation to the design parameters of the first refractive lens group 151 and/or the second refractive lens group 152 during the actual simulation or manufacturing.

A light incident side of the light splitting device 160 is arranged in a light exit direction of a light exit side of the double-telecentric lens 150 and the light splitting device 160 is arranged on an image side of the double-telecentric lens 150; and the light splitting device 160 has an optical power of 24 mm. The light splitting device 160 may be made of an H-K9L colorless optical glass. In other embodiments, the material for manufacturing the light splitting device 160 and the color of the material may be selected according to the actual needs. Specifically, the material and the color of the material may be designed according to the actual needs, which are not limited to those in the embodiment and the drawing of the present disclosure.

It should be noted that the optical power of the light splitting device 160 is only a design parameter obtained by software simulation in the embodiment as illustrated in FIG. 4 of the present disclosure. In practice, depending on different beam propagation paths, the specific design parameter of the light splitting device 160 may also be other parameters obtained according to software simulation. The examples according to the embodiments of the present disclosure are not intended to construe any limitation to the design parameter of the light splitting device 160 during the actual simulation or manufacturing.

In the embodiment of the present disclosure, the light splitting device 160 is a device configured to split light for the light beam of the first image P1 and the light beam of the second image P2, and achieves light splitting by swinging to enter the optical path where necessary by means of reflection. Specifically, as illustrated in FIG. 6 which illustrates a schematic structural diagram of a light splitting device 160 in a top view direction according to an embodiment of the present disclosure, the light splitting device 160 is a device capable of swinging. In response to swinging to the first angle, the light splitting device 160 enters the optical path and reflects the light exiting from the double-telecentric lens 150; or in response to not swinging or swinging to the initial position, the light splitting device 160 is not positioned in the optical path and does not reflect the light exiting from the double-telecentric lens. The swinging may be clockwise or counterclockwise. Further, the light splitting device 160 may also be coated with a highly reflection film. Specifically, the first angle, the frequency and amplitude of the light splitting device 160, configuration of the highly reflective film, and a film stack thereof may be designed according to the actual needs, which are not limited to those in the embodiments of the present disclosure.

In addition, the first driving device 191 is connected to the controller 180 and the light splitting device 160, and configured to drive, in response to a control instruction issued by the controller 180, the light splitting device 160 to swing and move. The light splitting device 160 is positioned in the optical path in the light exit direction of the double-telecentric lens 150 in response to swinging to the first angle, such that the light beam of the first image P1 is reflected into the first lens 110; or the light splitting device 160 is not positioned in the optical path in the light exit direction of the double-telecentric lens 150 in response to swinging to the initial position, such that the light beam of the second image P2 is reflected by the second reflection unit 170 into the second lens 120.

It should be noted that during adjustment by the double-telecentric lens 150, the light splitting device 160 also needs to be correspondingly adjusted. Specifically, a center of the light splitting device 160 needs to be arranged on an image side of a relay image P3 imaged by the double-telecentric lens 150, and a position of the light splitting device 160 may be adjusted by using the first driving device 191, such that a light beam is normally imaged in response to being reflected or transmitted from the light splitting device 160.

A light incident side of the first lens 110 is arranged in a light exit direction of a light reflection side of the light splitting device 160; and the first lens 110 has an optical power of 12 mm, and the first lens 110 has a focal length of 8.6 mm. Specifically, the first lens 110 may be a single lens or a lens group composed of a plurality of lenses, and may also contain other optical instruments. In practical application scenarios, the first lens 110 may be configured according to the actual needs, which is not limited to that in the embodiment of the present disclosure. It should be noted that the optical power and focal length of the first lens 110 are only design parameters obtained by software simulation in the embodiment as illustrated in FIG. 4 of the present disclosure. In practice, depending on different beam propagation paths, the specific design parameters of the first lens 110 may also be other parameters obtained according to software simulation. The examples according to the embodiments of the present disclosure are not intended to construe any limitation to the design parameters of the first lens 110 during the actual simulation or manufacturing.

A light incident side of the second reflection unit 170 is arranged in a light exit direction of a light transmission side of the light splitting device 160. The second reflection unit 170 is a mirror arranged at a second predetermined angle between the light splitting device 160 and the second lens 120. The second reflection unit 170 may also include a reflection enhancement film coated on the mirror to achieve total reflection of the light beams. In the embodiment illustrated in FIG. 4, an inclined face of the second reflection unit 170 has a reflection angle of 90 degrees, that is, the second predetermined angle of the second reflection unit 170 is 45 degrees, and the second reflection unit 170 is arranged in the optical path at the predetermined angle. In some other embodiments, the model and material of the second reflection unit 170, and the second predetermined angle may be selected according to the actual needs, which are not limited to those in the embodiment of the present disclosure.

A light incident side of the second lens 120 is arranged in a light exit direction of a light reflection side of the second reflection unit 170; and the second lens 120 has an optical power of 40 mm, and the second lens 120 has a focal length of 24 mm. Specifically, the second lens 120 may be a single lens or a lens group composed of a plurality of lenses, and may also contain other optical instruments. In practical application scenarios, the second lens 120 may be configured according to the actual needs, which is not limited to that in the embodiment of the present disclosure. It should be noted that the optical power and focal length of the second lens 120 are only design parameters obtained by software simulation in the embodiment as illustrated in FIG. 4 of the present disclosure. In practice, depending on different beam propagation paths, the specific design parameters of the second lens 120 may also be other parameters obtained according to software simulation. The examples according to the embodiments of the present disclosure are not intended to construe any limitation to the design parameters of the second lens 120 during the actual simulation or manufacturing.

The projection optical system 100, according to the embodiment of the present disclosure, manufactured by using the above mentioned design parameters, has a size that may be wholly controlled within 80 mm×90 mm in horizontal and vertical lengths in the direction as illustrated in FIG. 3. A width at a maximum position may be controlled within 40 mm in the width perpendicular to the image as illustrated in FIG. 3 (that is, perpendicular to paper). Therefore, the projection optical system 100 is relatively small in size with respect to the conventional projection optical system applicable to the head-up display device mounted on an automobile.

The controller 180 is connected to the image generation unit 130 and the light splitting device 160, and configured to control, based on timing, an image emitted by the image generation unit 130 and light exiting from the light splitting device 160. The controller 180 is configured to control, in response to controlling the image generation unit 130 to emit the first image P1, the light to exit only from the light reflection side of the light splitting device 160, such that the first image P1 is emitted and imaged through the first lens 110; or the controller 180 is configured to control, in response to controlling the image generation unit 130 to emit the second image P2, the light to exit only from the light transmission side of the light splitting device 160, such that the second image P2 is emitted and imaged through the second lens 120. The controller 180 may be various types of chips, modules, units, apparatuses and/or devices with a computing function, such as a processor and a server, commonly used for optical projection and capable of sending a control instruction. Further, the controller 180 may also have a computing function and/or a control function that projection devices usually have, such as communicating with the outside and/or accepting user gesture actions or instructions, and the like. Specifically, a corresponding controller 180 may be selected according to the actual needs, which is not limited to the embodiment of the present disclosure.

As described in the above application scenario, the automobile 1 further includes a front windshield a, and in the projection optical system 100, relay images P3 of the first lens 110 and the second lens 120 are imaged on the front windshield a. In the embodiment of the present disclosure, the controller 180 is further connected to the first lens 110 and the second lens 120, and configured to adjust, by controlling positions of the first lens 110 and the second lens 120, a virtual image distance between the first image P1 and the second image P2 in response to the first image P1 and the second image P2 being imaged on the front windshield a. Specifically, the second driving device 192 is connected to the controller 180 and the first lens 110, and configured to drive, in response to a control instruction issued by the controller 180, the first lens 110 to adjust an imaging position of light exiting from the first lens 110; and the third driving device 193 is connected to the controller 180 and the second lens 120, and configured to drive, in response to a control instruction issued by the controller 180, the second lens 120 to adjust an imaging position of light exiting from the second lens 120.

In the case of displaying two images using the projection optical system according to the embodiment of the present disclosure, using the application scenarios illustrated in FIG. 1 and FIG. 2 as examples, during a time period from t1 to t2, the image generation unit 130 plays the first image P1, and the light splitting device 160 swings to the optical path and blocks the light, such that the light is reflected to the first lens 110 to display the first image P1; during a time period from t2 to t3, the image generation unit 130 plays the second image P2, the light splitting device 160 swings back to the initial position and does not block the light, and the light reaches the second lens 120 to display the second image P2; then, by repeating the above steps during the above time periods, the image generation unit 130 cyclically plays the first image P1 and the second image P2, and meanwhile the light exiting from the light splitting device 160 is cyclically controlled. Preferably, in order that human eyes see that the first image P1 and the second image P2 are displayed simultaneously, play time of the first image P1 (t2−t1) and play time of the second image P2 (t3−t2) may be controlled within 0.1 to 0.4 seconds by using the phenomenon of persistence of vision, such that different display contents and pictures are played and displayed by means of timing control. Further, the distance and size of the virtual image presented on the front windshield a may also be adjusted by adjusting the focal lengths, or positions of the first lens 110 and the second lens 120, or even by using lenses of different magnifications, or the like. Further, the size of the virtual image presented on the front windshield a may also be adjusted by adjusting the focal lengths or positions of the first refractive lens group 151 and/or the second refractive lens group 152 in the double-telecentric lens 150, or even by using lenses of different magnifications, or the like.

It should be noted that the first driving device 191, the second driving device 192, the third driving device 193, and/or the fourth driving device 194 may respectively drive the light splitting device 160, the first lens 110, the second lens 120, and/or the double-telecentric lens 150 mechanically, may respectively drive the light splitting device 160, the first lens 110, the second lens 120, and/or the double-telecentric lens 150 in a software drive fashion, or may respectively drive the light splitting device 160, the first lens 110, the second lens 120, and/or the double-telecentric lens 150 in a software-plus-hardware fashion. For example, these elements are driven by using a servo/a motor, or driven by wired/wireless connection between the controller 180 and a server/a system/an electronic device, or driven by using a switch transistor/a switch circuit, and the like. Specifically, configurations may be made according to the actual needs, which are not limited to those in the embodiment of the present disclosure.

### Second Embodiment

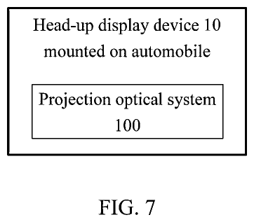

This embodiment of the present disclosure provides a head-up display device mounted on an automobile. The automobile may be the automobile 10 as described in the above mentioned application scenario, and the head-up display device may be the head-up display device as described in the above mentioned application scenario. Referring to FIG. 7, a structure of a head-up display device 10 mounted on an automobile according to an embodiment of the present disclosure is illustrated. The head-up display device 10 includes the projection optical system 100 as described in the first embodiment, wherein the projection optical system 100 is capable of projecting the first image P1 and/or the second image P2 onto the front windshield a of the automobile 10 to achieve imaging.

It should be noted that the specific structure of the projection optical system 100 is as described in the first embodiment, and reference may be made to the description of the projection optical system 100 in the first embodiment, which is not described in detail herein.

The embodiments of the present disclosure provide a projection optical system applicable to a head-up display device mounted on an automobile. The projection optical system includes an image generation unit, a first reflection unit, a double-telecentric lens, a light splitting device, a first lens, a second reflection unit, and a second lens that are successively arranged in a light exit direction; and further includes a controller connected to the image generation unit and the light splitting device, and configured to control, based on timing, an image emitted from the image generation unit and light exiting from the light splitting device; wherein the light splitting device is in a sector shape in a top view direction, and arranged on an image side of the double-telecentric lens; and the controller is configured to control, in response to controlling the image generation unit to emit a first image, the light splitting device to swing to a first angle, such that the first image is emitted and imaged through the first lens, or the controller is configured to control, in response to controlling the image generation unit to emit a second image, the light splitting device to swing to an initial position, such that the second image is emitted and imaged through the second lens. The projection optical system according to the present disclosure is capable of displaying, by means of timing control, different contents and pictures at two different positions, and in addition, the system has advantages of small size and low cost.

It should be noted that the above described device embodiments are merely for illustration purpose only. The units which are described as separate components may be physically separated or may be not physically separated, and the components which are illustrated as units may be or may not be physical units, that is, the components may be located in the same position or may be distributed into a plurality of network units. Part or all of the modules may be selected according to the actual needs to achieve the objectives of the technical solutions of the embodiments.

Finally, it should be noted that the above embodiments are merely used to illustrate the technical solutions of the present disclosure rather than limiting the technical solutions of the present disclosure. Under the concept of the present disclosure, the technical features of the above embodiments or other different embodiments may be combined, the steps therein may be performed in any sequence, and various variations may be derived in different aspects of the present disclosure, which are not detailed herein for brevity of description. Although the present disclosure is described in detail with reference to the above embodiments, persons of ordinary skill in the art should understand that they may still make modifications to the technical solutions described in the above embodiments, or make equivalent replacements to some of the technical features; however, such modifications or replacements do not cause the essence of the corresponding technical solutions to depart from the spirit and scope of the technical solutions of the embodiments of the present disclosure.

What is claimed is:

1. A projection optical system, applicable to a head-up display device mounted on an automobile, comprising:
an image generation unit, configured to emit light beams comprising image information of a first image and a second image;
a first reflection unit, a light incident side of the first reflection unit being arranged in a light exit direction of the image generation unit;
a double-telecentric lens, a light incident side of the double-telecentric lens being arranged in a light exit direction of a light reflection side of the first reflection unit;
a light splitting device, a light incident side of the light splitting device being arranged in a light exit direction of a light exit side of the double-telecentric lens, the light splitting device being arranged on an image side of the double-telecentric lens, and the light splitting device being in a sector shape in a top view direction;
a first lens, a light incident side of the first lens being arranged in a light exit direction of a light reflection side of the light splitting device;
a second reflection unit, a light incident side of the second reflection unit being arranged in a light exit direction of the double-telecentric lens;
a second lens, a light incident side of the second lens being arranged in a light exit direction of a light reflection side of the second reflection unit; and
a controller, connected to the image generation unit and the light splitting device, and configured to control, based on timing, an image emitted from the image generation unit and the light splitting device to swing; wherein
the controller is configured to control, in response to controlling the image generation unit to emit the first image, the light splitting device to swing from an initial position to a first angle to reflect light exiting from the double-telecentric lens, such that the first image is emitted and imaged through the first lens, or
the controller is configured to control, in response to controlling the image generation unit to emit the second image, the light splitting device to swing to an initial position to not reflect light exiting from the double-telecentric lens, such that the second image is emitted and imaged through the second lens.

2. The projection optical system according to claim 1, wherein
the light splitting device is a sector-shaped mirror, and the light splitting device is configured to swing about a center thereof as a central axis; and the projection optical system further includes:
a first driving device, connected to the controller and the light splitting device, and configured to drive, in response to a control instruction issued by the controller, the light splitting device to swing and move; wherein
in response to swinging to the first angle, the light splitting device is positioned in an optical path in the light exit direction of the double-telecentric lens, such that the light beam of the first image is reflected into the first lens, or
in response to swinging to the initial position, the light splitting device is not positioned in an optical path in the light exit direction of the double-telecentric lens, such that the light beam of the second image is reflected by the second reflection unit into the second lens.

3. The projection optical system according to claim 2, wherein
the automobile further comprises a front windshield, wherein the front windshield is a diffuser, and in the projection optical system, relay images of the first lens and the second lens are imaged on the front windshield; and
the controller is further connected to the first lens and the second lens, and configured to adjust, by controlling positions of the first lens and the second lens, a virtual image distance between the first image and the second image in response to the first image and the second image being imaged on the front windshield; and
the projection optical system further comprises:
a second driving device, connected to the controller and the first lens, and configured to drive, in response to a control instruction issued by the controller, the first lens to adjust an imaging position of light exiting from the first lens; and
a third driving device, connected to the controller and the second lens, and configured to drive, in response to a control instruction issued by the controller, the second lens to adjust an imaging position of light exiting from the second lens.

4. The projection optical system according to claim 3, wherein
the double-telecentric lens comprises a first refractive lens group and a second refractive lens group, and the controller is configured to adjust a size of the image by controlling positions of the first refractive lens group and the second refractive lens in the double-telecentric lens; and
the projection optical system further comprises:
a fourth driving device, connected to the controller and the double-telecentric lens, and configured to drive, in response to a control instruction issued by the controller, the first refractive lens group and the second refractive lens group to adjust image sizes of light exiting from the first refractive lens group and the second refractive lens group.

5. The projection optical system according to claim 4, wherein
the first reflection unit is a turning prism, arranged at a first predetermined angle between the image generation unit and the double-telecentric lens; and
the second reflection unit is a mirror, arranged at a second predetermined angle between the light splitting device and the second lens.

6. The projection optical system according to claim 5, wherein
an optical power of the first refractive lens group is 15 mm, and a focal length of the first refractive lens group is 8.6 mm; and
an optical power of the second refractive lens group is 8 mm, and a focal length of the second refractive lens group is 6 mm.

7. The projection optical system according to claim 6, wherein
an optical power of the first lens is 12 mm, and a focal length of the first lens is 8.6 mm; and
an optical power of the second lens is 40 mm, and a focal length of the second lens is 24 mm.

8. The projection optical system according to claim 7, wherein an optical power of the light splitting device is 24 mm.

9. The projection optical system according to claim 8, wherein the image generation unit is a DLP display chip or an LCOS display chip.

10. A head-up display device mounted on an automobile, comprising a projection optical system, wherein the projection optical system comprises:
an image generation unit, configured to emit light beams comprising image information of a first image and a second image;
a first reflection unit, a light incident side of the first reflection unit being arranged in a light exit direction of the image generation unit;
a double-telecentric lens, a light incident side of the double-telecentric lens being arranged in a light exit direction of a light reflection side of the first reflection unit;
a light splitting device, a light incident side of the light splitting device being arranged in a light exit direction of a light exit side of the double-telecentric lens, the light splitting device being arranged on an image side of the double-telecentric lens, and the light splitting device being in a sector shape in a top view direction;
a first lens, a light incident side of the first lens being arranged in a light exit direction of a light reflection side of the light splitting device;
a second reflection unit, a light incident side of the second reflection unit being arranged in a light exit direction of the double-telecentric lens;
a second lens, a light incident side of the second lens being arranged in a light exit direction of a light reflection side of the second reflection unit; and
a controller, connected to the image generation unit and the light splitting device, and configured to control, based on timing, an image emitted from the image generation unit and the light splitting device to swing; wherein
the controller is configured to control, in response to controlling the image generation unit to emit the first image, the light splitting device to swing from an initial position to a first angle to reflect light exiting from the double-telecentric lens, such that the first image is emitted and imaged through the first lens, or
the controller is configured to control, in response to controlling the image generation unit to emit the second image, the light splitting device to swing to an initial position to not reflect light exiting from the double-telecentric lens, such that the second image is emitted and imaged through the second lens, wherein
the projection optical system is capable of projecting the first image and/or the second image onto a front windshield of the automobile such that imaging is achieved on the front windshield.

11. The head-up display device mounted on an automobile according to claim 10, wherein
the light splitting device is a sector-shaped mirror, and the light splitting device is configured to swing about a center thereof as a central axis; and the projection optical system further includes:
a first driving device, connected to the controller and the light splitting device, and configured to drive, in response to a control instruction issued by the controller, the light splitting device to swing and move; wherein
in response to swinging to the first angle, the light splitting device is positioned in an optical path in the light exit direction of the double-telecentric lens, such that the light beam of the first image is reflected into the first lens, or
in response to swinging to the initial position, the light splitting device is not positioned in an optical path in the light exit direction of the double-telecentric lens, such that the light beam of the second image is reflected by the second reflection unit into the second lens.

12. The head-up display device mounted on an automobile according to claim 11, wherein
the automobile further comprises a front windshield, wherein the front windshield is a diffuser, and in the projection optical system, relay images of the first lens and the second lens are imaged on the front windshield; and
the controller is further connected to the first lens and the second lens, and configured to adjust, by controlling positions of the first lens and the second lens, a virtual image distance between the first image and the second image in response to the first image and the second image being imaged on the front windshield; and
the projection optical system further comprises:
a second driving device, connected to the controller and the first lens, and configured to drive, in response to a control instruction issued by the controller, the first lens to adjust an imaging position of light exiting from the first lens; and
a third driving device, connected to the controller and the second lens, and configured to drive, in response to a control instruction issued by the controller, the second lens to adjust an imaging position of light exiting from the second lens.

13. The head-up display device mounted on an automobile according to claim 12, wherein
the double-telecentric lens comprises a first refractive lens group and a second refractive lens group, and the controller is configured to adjust a size of the image by controlling positions of the first refractive lens group and the second refractive lens in the double-telecentric lens; and
the projection optical system further comprises:
a fourth driving device, connected to the controller and the double-telecentric lens, and configured to drive, in response to a control instruction issued by the controller, the first refractive lens group and the second refractive lens group to adjust image sizes of light exiting from the first refractive lens group and the second refractive lens group.

14. The head-up display device mounted on an automobile according to claim 13, wherein
the first reflection unit is a turning prism, arranged at a first predetermined angle between the image generation unit and the double-telecentric lens; and
the second reflection unit is a mirror, arranged at a second predetermined angle between the light splitting device and the second lens.

15. The head-up display device mounted on an automobile according to claim 12, wherein
an optical power of the first refractive lens group is 15 mm, and a focal length of the first refractive lens group is 8.6 mm; and
an optical power of the second refractive lens group is 8 mm, and a focal length of the second refractive lens group is 6 mm.

16. The head-up display device mounted on an automobile according to claim 15, wherein
an optical power of the first lens is 12 mm, and a focal length of the first lens is 8.6 mm; and
an optical power of the second lens is 40 mm, and a focal length of the second lens is 24 mm.

17. The head-up display device mounted on an automobile according to claim 16, wherein
wherein an optical power of the light splitting device is 24 mm.

18. The head-up display device mounted on an automobile according to claim 17, wherein
the image generation unit is a DLP display chip or an LCOS display chip.
